(19) United States
(12) Patent Application Publication
(10) Pub. No.: US 2014/0099593 A1
(43) Pub. Date: Apr. 10, 2014

(54) MONOLITHIC METALLIC SELF-LIGATING BRACKET WITH LOCKING CATCH DEVICES

(71) Applicant: Beijing Smart Technology Co., LTD., Beijing (CN)

(72) Inventors: Huang BINGMIN, Beijing (CN); Zhang DONGLIANG, Beijing (CN); Lin LIN, Beijing (CN); Chen HUA, Beijing (CN)

(73) Assignee: BEIJING SMART TECHNOLOGY CO., LTD., Beijing (CN)

(21) Appl. No.: 14/104,673

(22) Filed: Dec. 12, 2013

Related U.S. Application Data
(62) Division of application No. 13/015,843, filed on Jan. 28, 2011.

(30) Foreign Application Priority Data
Aug. 27, 2010 (CN) 201020507699.8

(51) Int. Cl. A61C 7/30

(52) U.S. Cl. CPC A61C 7/30
USPC 433/11

(57) ABSTRACT

A monolithic metallic self-ligating bracket with a locking catch device is provided. The bracket includes a base, at least one tie wing and at least one locking catch device placed on one surface of the base. A slot in the middle of the tie wing extends in a generally mesial-distal direction. One end of a trailing arm connects with the base, and the other end of the trailing arm extends transversely toward the axis to form an arm tip, the inner edge of the trailing arm and arm tip towards the axis, together with the slot form an archwire concave. After the arch wire is inserted to the archwire concave, the locking catch device returns to its original shape, and the arm tip extending into the archwire concave of the locking catch device enclasps the arch wire, making the best use of the therapeutic force of the archwire.

This application is a divisional of U.S. patent application Ser. No. 13/015,843, filed Jan. 28, 2011, which claims priority to Chinese Patent Application No. 201020507699.8, filed Aug. 27, 2010, the entire disclosures are expressly incorporated by reference herein.

### FIELD OF THE INVENTION

The present invention is directed toward an orthodontic appliance of dentistry, more particularly, the present invention relates to a monolithic metallic self-ligating bracket with locking catch devices.

### BACKGROUND OF THE INVENTION

Orthodontic treatment is an important branch discipline with a high level of specialization of dentistry, concerning with the treatment of malocclusions (improper bites), which may be a result of tooth irregularity, disproportionate jaw relationships, or both. Orthodontic treatment focuses on the treatment of the malformation of teeth, jaw bones and face, and provides the patient with a functionally improved bite by fixing an orthodontic appliance in the patient's oral cavity. Brackets are important parts of an orthodontic appliance, mainly bonded to patients' anterior, cuspid and bicuspid teeth, and the arch wire fixed in the slot of brackets provides the therapeutic force that pushes the tooth in a particular direction, to align and correct the tooth to their right positions. Orthodontic treatment provides the patient with a functionally improved bite and improves the general appearance of patients' teeth.

Traditionally, metal ligatures or elastic ligatures (O-ring elastic) are applied to fix the arch wire into the slot of the brackets, but there are several disadvantages of this method such as time consuming and inconvenience for clinical operation, high friction, and discomfort. In recent years, self-ligating brackets as a new method for orthodontic treatment of the dental displacement and malformation are developed. The greatest feature of the self-ligating bracket is ligating the arch wire with the self-locking device portion of the bracket itself, instead of metal or elastic ligature, so that the friction of the interior of the orthodontic appliance is reduced, and treatment efficiency is improved remarkably. The self-ligating bracket is a rapid, comfortable and safe orthodontic appliance. So far, compared with traditional brackets, the self-ligating bracket is with particular advantages such as lower friction, better anchorage control, improved clinic operation efficiency, and more lightly pain, and also has stable structure for intermeshing, small and exquisite appearance, higher patients' comfort, easier cleanness, shorter treatment duration, lower frequency of clinic visits, higher treatment efficiency, and shorter treatment course. Self-ligating bracket has been accepted by more and more orthodontists.

There are generally two types of self-ligating bracket, a passive slide or a spring clip. The passive slide bracket sets sliding closures on both sides of the slot, and forms a solid and closed pipe where the arch wire can move freely by pushing the sliding closures after the arch wire is fixed in the slot, so the passive slide bracket can also be called passive self-ligating bracket. The spring clip bracket has a built-in locking catch device with high elasticity, which can generate an elastic pressure that can act on the arch wire if necessary after being closed, and provides continuous and soft treatment force, so the spring clip bracket can also be called active self-ligating bracket. Most self-ligating brackets are with self-locking device portion on the surface of the bracket metal, and easy for locking and unlocking by tools or fingertip, which lead to a more convenient ligature process.

However, self-ligating brackets are still with limitations during clinical application. For example, self-ligating brackets are difficult to be located precisely in adhesive process, because compared to the conventional twin-tie wing bracket, most self-ligating bracket are with quite different patterns: the structure of the self-ligating bracket is more complicated, and its twin-tie wings are inapparent, which may cause inconvenience for the orthodontists clamping and placing the bracket, result in the difficultly fit of the self-ligating brackets panels and the radian of the dentalface and imprecise bracket locating. Imprecise bracket locating will increase the difficulty of precise teeth adjustment in the finishing stage of the treatment, lengthen the precise teeth adjustment period accordingly, and bring inconvenience to the clinical operation.

On the other hand, the design of some current self-ligating bracket is found unsatisfactory. For example, if the slide closure or locking catch device opens under some unexpected situations, the brackets will lose their control of the arch wire that will influence the treatment effect and lengthen the treatment time. And since the structure of most self-ligating bracket are precise and complicated, the self-ligating bracket may be damaged by external forces (including masticatory force) or improper operation by the orthodontists, which may lead to the slide closure or locking catch device working disability even the damage of the whole bracket, increase the patients' financial burdens and the cost of treatment.

Moreover, in most conditions, the self-locking device portion of the self-ligating bracket occupies a sizable space on the surface of the teeth, resulting in a relatively thick bracket, so that the bracket is possible to be dropped off during mastication, and has limitations especially for the children with poor compliance and deep over-bite patients. Due to the short and obtuse tie wings of the self-ligating bracket, it is difficult to ligate some accessories onto the bracket and the ligation may slip. When the orthodontists insert or remove the arch wire from the self-ligating bracket, there is a higher patients' discomfort and pain in comparison to the traditional twin-tie wing bracket. And during individual teeth adjustment by rectangular stainless steel wire with loops, it is not easy to engage the arch wire and lock the arch wire slot by slip closure or locking catch device. These are the limitations of the self-ligating bracket in the application of the conventional precise adjustment operation.

### SUMMARY OF THE INVENTION

By analyzing the disadvantages of the traditional self-ligating bracket, the present invention directed to a monolithic metallic self-ligating orthodontic bracket with integrated tie wings and locking catch devices. With this bracket, the arch wire can be conveniently fixed to an archwire concave that formed by the slots of the tie wings and the cavity of the locking catch devices together. The self-ligating bracket is with good clipping and fixing force, and can afford repeated loading and unloading of the arch wire without deformation.

A monolithic metallic self-ligating bracket with locking catch devices comprises a base, at least one tie wing and at least one locking catch device placed on one surface of the base. Wherein the slot is in the middle of the tie wing and extends in a generally mesial-distal direction, and all slots of the tie wings are at one axis. Wherein the locking catch device includes a trailing arm, one end of the trailing arm connects with the base, and the other end of the trailing arm extends transversely toward the slot axis to form an arm tip. The inner edge of the trailing arm and arm tip towards the slot axis, together with the slot form an arch wire concave.

The tie wings, the locking catch devices and the base are processed by integral shaping method which process the tie wings, the locking catch devices and the base in an integrated construction by metal casting, metal powder injection molding (MIM), linear cutting, laser caving or laser cutting.

The base, the tie wings, and the locking catch devices of the bracket are made of Nickel-Titanium alloy, Nickel-Titanium based alloys, Titanium based alloys, Co—Cr alloys or Stainless Steel.

The locking catch devices are placed between tie wings and/or outside tie wings.

There is at least one group of locking devices that each group composed of two locking catch devices symmetrically placed on the two sides of the slot axis, and the groups are placed between the tie wings and/or outside the tie wings.

The two locking catch devices of a group join up at the base of the trailing arm, wherein said two trailing arms of the locking catch device and the inner edges of the arm tips towards the axis form a cavity, the shape of the cavity is a upturned “C” type with its mouth upwards.

The outer edge in the upper end of the arm tip of the locking catch device is smoothly curved into an arc that slants towards the arm tip's ending.

The locking catch devices are unsymmetrically placed on the two sides of the slot axis.

The locking catch devices are all placed at one same side of the axis.

The rest locking catch devices are unsymmetrically placed about the arch wire slot axis or all the rest locking catch devices are at one same side of the slot axis.

The present invention is directed toward a monolithic metallic self-ligating bracket including a base, and two tie wings and at least one locking catch device placed on one surface of the base. There are slots in the middle of the tie wings extending in a generally mesial-distal direction, and the inner edges of the locking catch device towards the axis together with the slot form a concave to hold arch wire. The tie wings, the locking catch devices and the base are processed by integral shaping method. Compared with gland self-ligating brackets, the monolithic metallic self-ligating bracket of the present invention forms an arch wire concave by the locking catch devices and the slots in the tie wings. After the arch wire inserted to the archwire concave, the locking catch devices return to its original shape immediately, and the arm tips extending into the archwire concave of the locking catch devices enclasp the arch wire stably and effectively, making the best possible use of the therapeutic force of the arch wire. So there is no necessity to add up an additional open-close device for the arch wire on the top of the tie wings, thus this self-ligating bracket is with relatively lower thickness and makes the patient more comfortable.

Because the present self-ligating bracket is with one-piece construction of the locking catch devices and the bracket portion, there is no hinge structure that is common used in conventional gland self-ligating bracket, so that it is easy for cleaning and keeping good hygiene. Since the locking catch devices are with good stability and elasticity, they can afford repeated loading and unloading of the arch wire without deformation, and keep good grip and retention forces. The locking catch devices exert elastic pressure after closed on the arch wire when needed, and providing constant and gentle therapeutic force.

### BRIEF DESCRIPTION OF THE DRAWINGS

FIG. 1 is a schematic structure drawing of the first embodiment of the present invention.

FIG. 2 is another schematic structure drawing of the first embodiment of the present invention.

FIG. 3 is a schematic structure drawing of the embodiment of the locking catch device.

FIG. 4 is a schematic structure drawing of the second embodiment of the present invention.

FIG. 5 is a schematic structure drawing of the third embodiment of the present invention.

FIG. 6 is a schematic structure drawing of the fourth embodiment of the present invention.

FIG. 7 is a schematic structure drawing of the fifth embodiment of the present invention.

FIG. 8 is a schematic structure drawing of the sixth embodiment of the present invention.

FIG. 9 is another schematic structure drawing of the sixth embodiment of the present invention.

FIG. 10 is a schematic structure drawing of the seventh embodiment of the present invention.

FIG. 11 is another schematic structure drawing of the seventh embodiment of the present invention.

FIG. 12 is a schematic structure drawing of the eighth embodiment of the present invention.

FIG. 13 is a schematic structure drawing of the ninth embodiment of the present invention.

FIG. 14 is another schematic structure drawing of the ninth embodiment of the present invention.

### DETAILED DESCRIPTION OF THE PREFERRED EMBODIMENT

The examples described below are intended to exemplify the various aspects and benefits of the present invention. Accordingly, the invention should not be deemed limited to the specific embodiments set out above in detail, but instead only by a fair scope of the claims that follow along with their equivalents.

### Embodiment 1

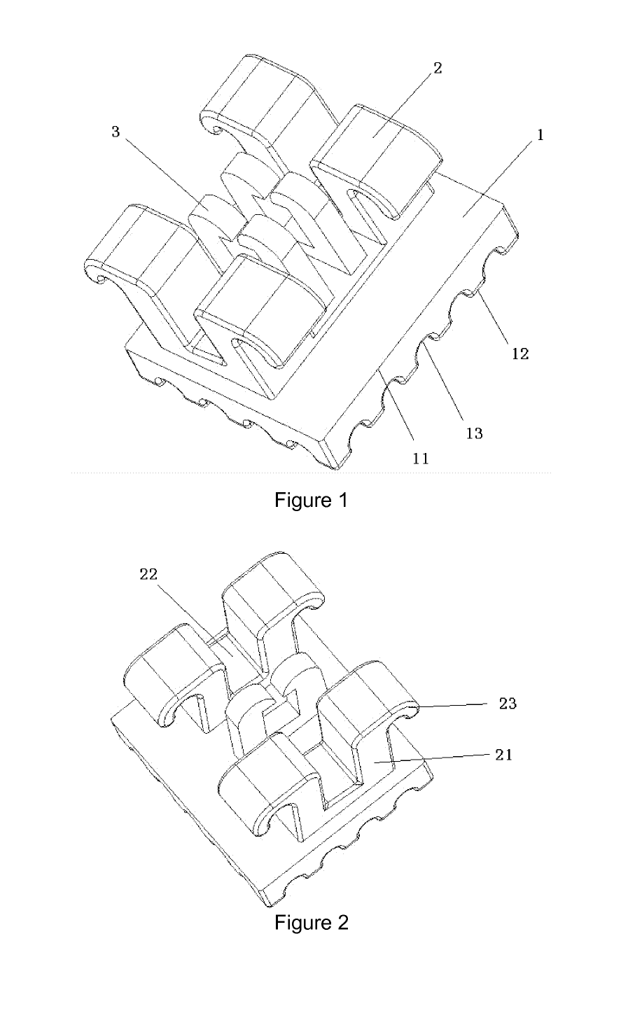

As shown in FIG. 1 and FIG. 2, the self-ligating bracket of present embodiment including base 1, two tie wings 2, 2N locking catch devices 3 (N is natural number), wherein tie wing 2 and locking catch devices 3 and base 1 are processed by integral shaping method such as metal casting, metal powder injection molding (MIM), linear cutting and so on. The self-ligating bracket is made of metallic material in its entirety, such as Nickel-Titanium alloy, Nickel-Titanium based alloys, Titanium based alloys, Co—Cr alloys or Stainless Steel. Base 1 is a board with generally cuboid shape, whose front side is surface 11, back side is the bonding surface 12, wherein surface 11 is a smooth plane, the bonding surface 12 is with a ravine like grooves 13 in favor for binder's inflow to enhance the retention force of the bracket. Two tie wings 2 are placed in a mesial and distal direction of the surface 11 respectively, wherein tie wing 2 includes a support 21 that connected with surface 11, and a slot 22 formed by a downward hollowing from the top of support 21 for accommodating an arch wire, and then the two side walls of slot 22 extend outward respectively to form two excurvature wings 23. The slots 22 in the middle of tie wings 2 are in one axis. The two side walls of slot 22 are parallel or approximately parallel, and they are perpendicular or approximately perpendicular to the surface 11. As showed in the FIG. 4, there is a linear mark 5 perpendicular to the axis of slot 22 on surface 11, which can be used for clinical bonding location. Preferably, the linear mark 5 is placed in the midway of base 1, and the linear mark 5 can be a notch or ledge.

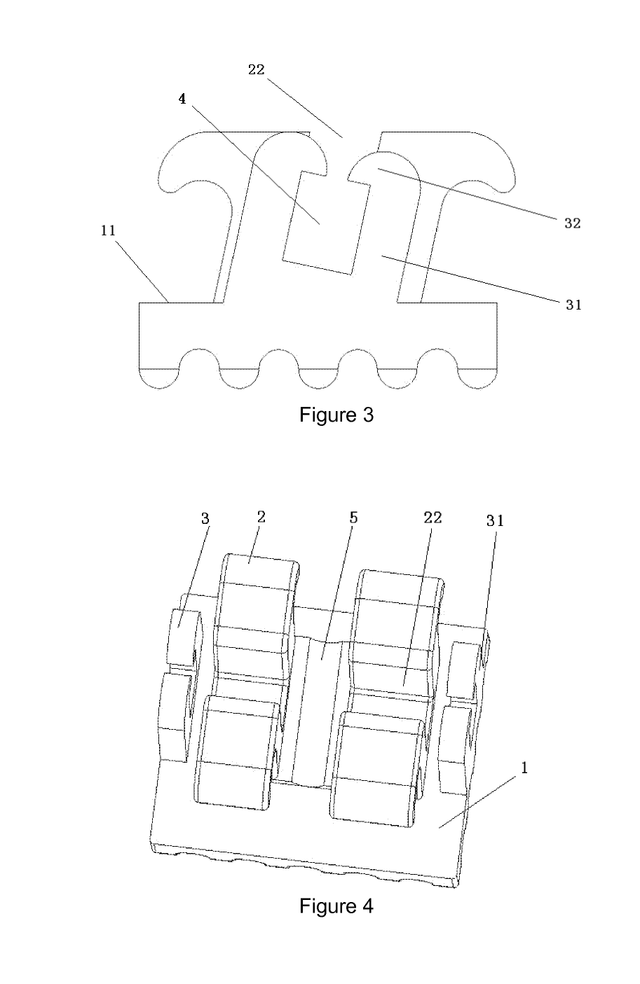

As showed in FIG. 3, the shape of a single locking catch device 3 is approximate to “7” type, including a trailing arm 31 and an arm tip 32, in which the trailing arm 31 is connected to the surface 11 in one end, and the other end extends horizontal toward the axis of slot 22 to form an arm tip 32 in the terminal. The locking catch device 3 extends along the surface 11. The inner edge (the edge towards the axis of slot 22) of the locking catch device 3 and the slot 22 of two tie wings 2 together form a rectangle archwire concave 4 that for accommodating the arch wire. The archwire concave 4 can be made a rectangle content to accommodate arch wire from 0.018×0.025 inch to 0.022×0.028 inch at its maximum if necessary. The outer edge in the end of the arm tip 32 is smoothly curved into an arc that slant toward its ending, when exerting pressure on arch wire from outside, arch wire will be inserted into the arch wire concave 4 smoothly from the ending of the arm tip 32. After arch wire inserted into the arch wire concave 4, the locking catch device 3 returns to its original shape immediately, so that the arm tip 32 enclasps the arch wire stably and effectively, to make the best possible use of the therapeutic force of the arch wire.

As showed in FIG. 1 and FIG. 2, the present embodiment including 2N locking catch devices 3 can be considered N groups, and the two locking catch devices of each group are symmetrically placed on the two sides of the axis of slot 22, where N groups of locking catch devices 3 are placed along the axis between two tie wings 2. In relaxed state, two opposed trailing arms 31 are parallel or approximately parallel, and they are perpendicular or approximately perpendicular to the surface 11, the gap between the two arm tips 32 forms the entrance for the archwire concave 4. Viewed along the axis of the slot 22, the entrance for archwire concave 4 is a sleek “V” with arch. When an external pressure exerted on an arch wire toward the entrance from outside, two opposed arm tips 32 are easily opened, the arch wire is pressed into the archwire concave 4 smoothly from the expanded entrance of the archwire concave 4. The two locking catch devices 3 of one group join up at the base of the trailing arm 31, the shape of the cavity between the two locking catch devices 3 is a roughly upturned “C” type with its mouth upward. The shape of the cavity between the two locking catch devices 3 is in conformity with the inner contour of the slot 22, the cavity and slot 22 form the archwire concave 4 together, which enhances the control and enclasping ability on archwire, and keep the arch wire fixed in the archwire concave 4 without bounce off within certain limits. When the recover force of the arch wire is over a certain limit after it inserted the archwire concave 4, the locking catch devices 3 will be separated in an opposite direction and the arch wire will bounce off from the archwire cavity 4, which could protect teeth from being hurt, and avoid the bracket dropping off from the fixing position by the excessive heavy therapeutic force.

### Embodiment 2

As showed in FIG. 4, on the basis of embodiment 1, the self-ligating bracket of the present embodiment is without the locking catch devices 3 that placed in the space between two tie wings 2, and there is a group of locking catch devices 3 placed on each external side of the two tie wings on the surface 11 along the slot 22 axis. The locking catch devices 3 of each group are symmetrically placed on the two sides of the axis of slot 22 and the two locking catch devices 3 of one group join up at the base of the trailing arm 31, the shape of the cavity between the two locking catch devices 3 is a roughly upturned “C” type with its mouth upward. The shape of the cavity between the two locking catch devices 3 is in conformity with the inner contour of the slot 22, the cavity and slot 22 form the archwire concave 4 together, which enhances the control and enclasping ability on an arch wire, and keeps the arch wire fixed without bounce off from the archwire concave 4 within certain limits.

### Embodiment 3

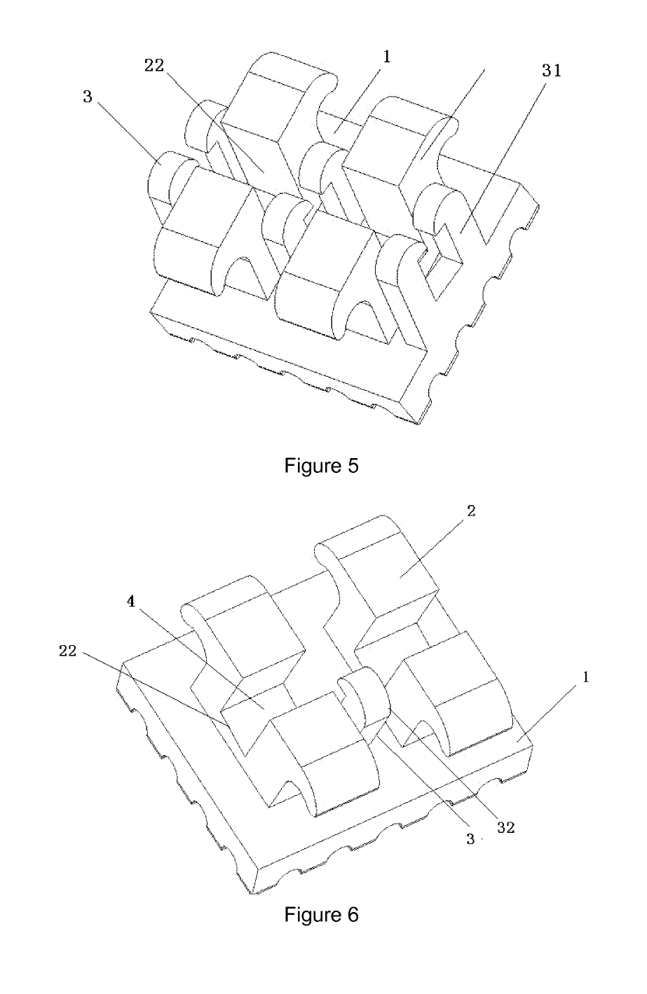

As showed in FIG. 5, on the basis of embodiment 1, the self-ligating bracket of the present embodiment is with a group of locking catch devices 3 placed on each external side of the two tie wings 2 on the surface 11 along the axis of slot 22. The two locking catch devices 3 of each group are symmetrically placed on the two sides of the axis of slot 22 and the two locking catch devices 3 of one group join up at the base of the trailing arm 31. The shape of the cavity between the two locking catch devices 3 is a roughly upturned “C” type with its mouth upward. The shape of the cavity between the two locking catch devices 3 is in conformity with the inner contour of the slot 22, the cavity and slot 22 form the archwire concave 4 together, which enhances the control and enclasping ability on a arch wire, and keeps the arch wire fixed without bounce off from the archwire concave 4 within certain limits.

### Embodiment 4

As shown in the FIG. 6, the self-ligating bracket of the present embodiment including a base 1, two tie wings 2, N locking catch devices 3 (N is a natural number), tie wings 2 and locking catch devices 3 and base 1 are produced integrally. All the locking catch devices 3 are placed at one side of the slot 22 axis, the arm tip 32 is in the direction toward the slot 22 axis. The inner edges of all the locking catch devices 3 are in conformity with one side of the inner contour of slot 22. The inner edges towards the axis of slot 22 of the locking catch devices 3 and slot 22 form the archwire concave 4 together for retaining the arch wire.

### Embodiment 5

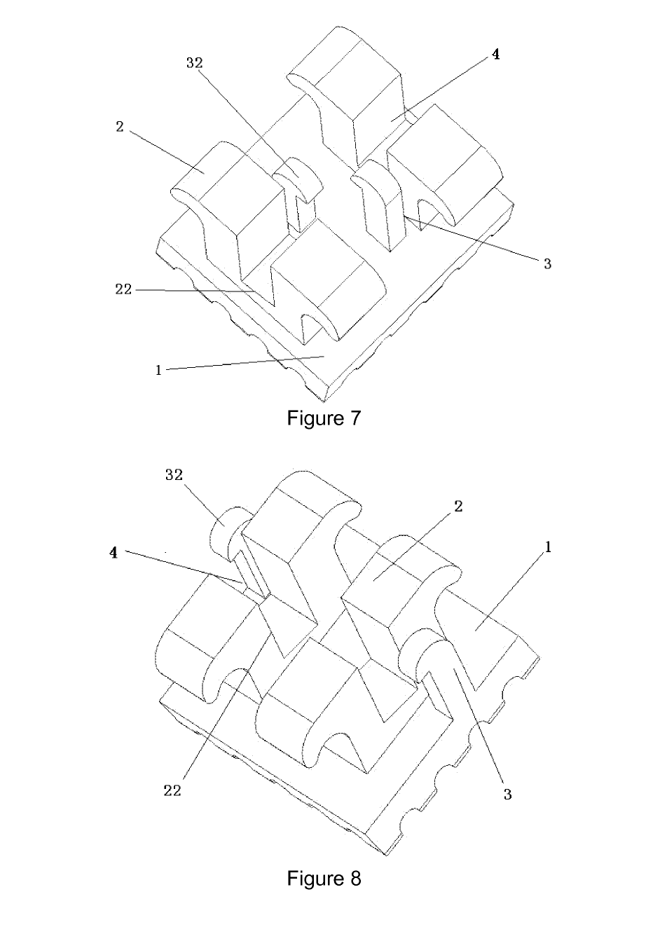

As showed in FIG. 7, on the basis of embodiment 1, the self-ligating bracket of the present embodiment are with locking catch devices 3 unsymmetrically placed about the slot 22 axis instead of symmetrically, the arm tip 32 is in the direction toward the slot 22 axis. The locking catch devices 3 on one side of the slot 22 axis are staggered with the locking catch devices 3 on the other side of the slot 22 axis, thus the locking catch devices 3 are not symmetrically placed about the slot 22 axis. Tie wings 2 and clips 3 and base 1 are formed integrally. The inner edges of all the locking catch devices 3 are in conformity with one side of the inner contour of slot 22. The inner edges towards the slot 22 axis of the locking catch devices 3 and slot 22 form the archwire concave 4 together for retaining the arch wire.

### Embodiment 6

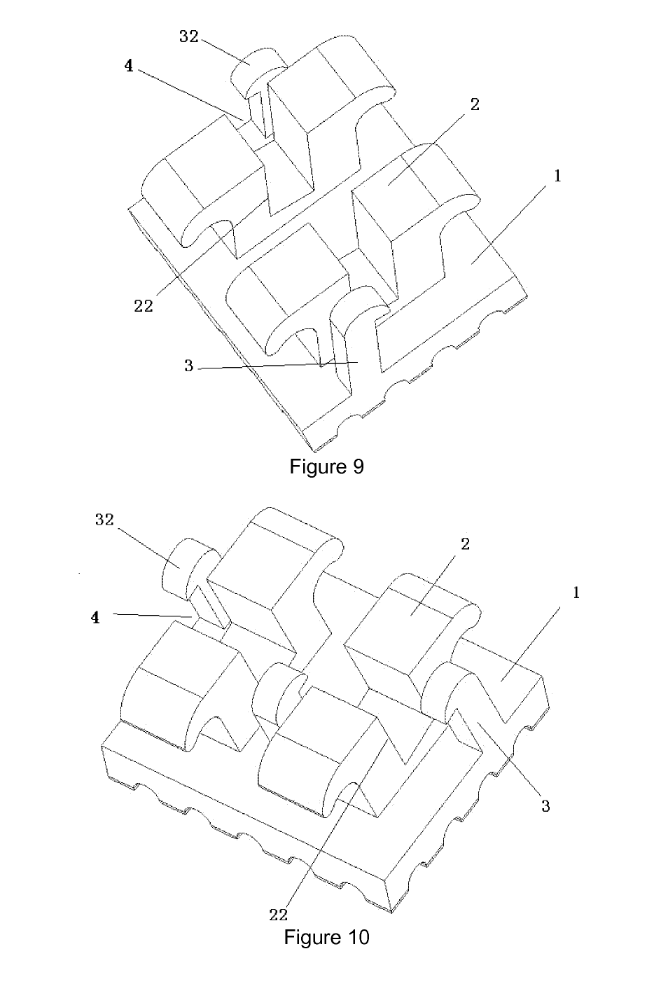

As showed in FIG. 8 and FIG. 9, on the basis of embodiment 2, the self-ligating bracket of the present embodiment is with one locking catch device 3 placed on each external side of the two tie wings 2 on the surface 11 along the slot 22 axis. Tie wings 2 and locking catch devices 3 and base 1 are formed integrally. The two locking catch devices 3 can be placed on the same sides of slot 22 or opposed sides. The arm tip 32 is in the direction toward the slot 22 axis. The inner edges of all the locking catch devices 3 are in conformity with one side of the inner contour of slot 22. The inner edges towards the slot 22 axis of the locking catch devices 3 and slot 22 form the archwire concave 4 together for retaining the archwire.

### Embodiment 7

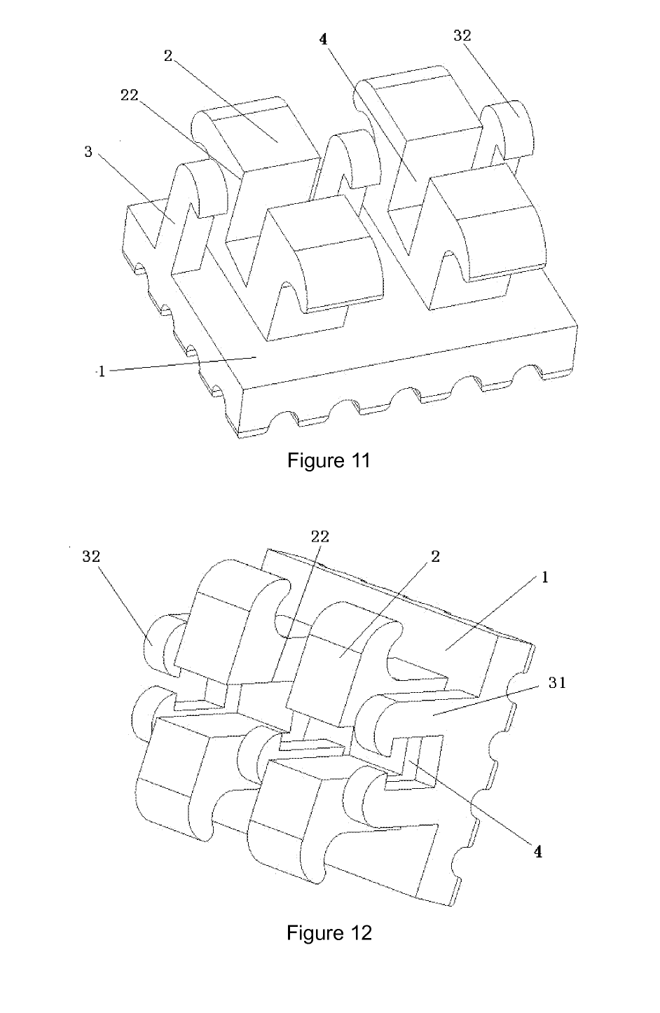

As showed in FIG. 10 and FIG. 11, on the basis of embodiment 6, the self-ligating bracket of the present embodiment is with one locking catch device 3 placed on each external side of the two tie wings 2 on the surface 11 along the slot 22 axis, besides, one more locking catch device 3 placed in the space between two tie wings 2. The arm tips 32 of all locking catch devices 3 are in the direction toward the slot 22 axis, locking catch devices 3 can be placed all on one side of slot 22 or on the opposed sides. Tie wings 2 and locking catch devices 3 and base 1 are made integrally. The inner edges of all the locking catch devices 3 are in conformity with one side of the inner contour of slot 22. The inner edges towards the slot 22 of the locking catch devices 3 and slot 22 form the archwire concave 4 together for retaining the arch wire.

### Embodiment 8

As showed in FIG. 12, on the basis of embodiment 7, the self-ligating bracket of the present embodiment is with one group locking catch devices 3 placed on each external side of the two tie wings 2 instead of one single locking catch device 3. The two locking catch devices 3 of one group are symmetrically placed about the slot 22 axis. The two locking catch devices 3 of one group join up at the base of the trailing arm 31, the shape of the cavity between the two locking catch devices 3 is a roughly upturned “C” type with its mouth upward. The shape of the cavity between the two locking catch devices 3 is in conformity with the inner contour of the slot 22, the cavity and slot 22 form the archwire concave 4 together, which enhances the control and enclasping ability on archwire, and keeps the arch wire fixed without bounce off within certain limits.

### Embodiment 9

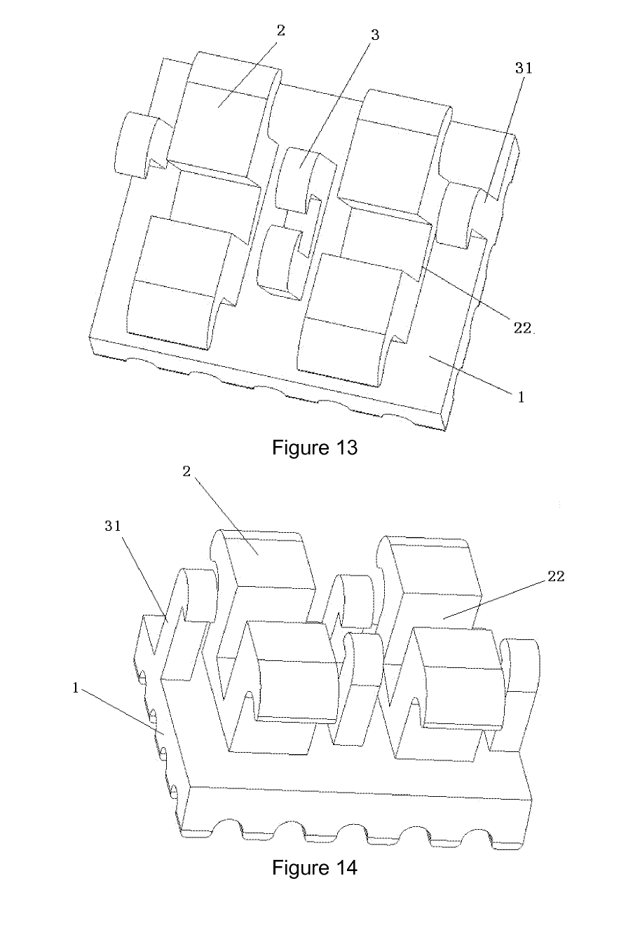

As showed in FIG. 13, FIG. 14, on the basis of embodiment 7, the self-ligating bracket of the present embodiment is with one group locking catch devices 3 placed in the space between two tie wings 2 instead of one single locking catch device 3. The two locking catch devices 3 of one group are symmetrically placed about the slot 22 axis. The two locking catch devices 3 of one group join up at the base of the trailing arm 31, the shape of the cavity between the two locking catch devices 3 is a roughly upturned “C” type with its mouth upward. The shape of the cavity between the two locking catch devices 3 is in conformity with the inner contour of the slot 22, the cavity and slot 22 form the archwire concave 4 together, which enhances the control and enclasping ability on archwire, and keeps the arch wire fixed without bounce off within certain limits.

The examples described above are intended to exemplify the various aspects and benefits of the present invention. However, those skilled in the art may recognize that a number of variations and additions to the appliances described above maybe made without departing from the spirit of the invention. Accordingly, the invention should not be deemed limited to the specific embodiments set out above in detail, but instead only by a fair scope of the claims that follow along with their equivalents.

1. A monolithic metallic self-ligating bracket with locking catch devices, comprising:
a base, at least two tie wings and at least two locking catch devices placed on one surface of the base;
wherein a slot that extends in a generally mesial-distal direction is in the middle of each of the at least two tie wings, wherein all slots of the at least two tie wings are configured to be aligned along an axis;
wherein each of the at least two locking catch devices includes a trailing arm,
wherein one end of the trailing arm connects with the base, and the other end of the trailing arm extends transversely toward the axis to form an arm tip;
wherein at least one of the at least two tie wings is placed between the two locking catch devices,
wherein the inner edge of the trailing arm and the arm tip are arranged towards the axis and, together with the slot, form an arch wire concave.

2. The monolithic metallic self-ligating bracket as claimed in claim 1, wherein the at least two tie wings, the at least two locking catch devices and the base are processed by an integral shaping method which processes the at least two tie wings, the at least two locking catch devices and the base in an integrated construction by metal casting, metal powder injection molding (MIM), linear cutting, laser caving or laser cutting.

3. The monolithic metallic self-ligating bracket as claimed in claim 1, wherein the base, the at least two tie wings, and the at least two locking catch devices the bracket are made of Nickel-Titanium alloy, Nickel-Titanium based alloys, Titanium based alloys, Co—Cr alloys or Stainless Steel.

4. The monolithic metallic self-ligating bracket as claimed in claim 1, further comprising more than two locking catch devices, wherein at least two of all the locking catch devices are placed between the at least two tie wings.

5. The monolithic metallic self-ligating bracket as claimed in claim 1, further comprising at least two groups of locking catch devices, wherein each group includes two locking catch devices which are symmetrically placed on two sides of the axis, and at least one of the at least two tie wings is placed between the two groups of locking catch devices.

6. The monolithic metallic self-ligating bracket as claimed in claim 5, wherein one end of the trailing arm of each of the two locking catch devices of each group connects with the base, and the other end of the trailing arm of each of the two locking catch devices of each group extends transversely toward the axis to form an arm tip, wherein the two trailing arms of the two locking catch devices and the inner edges of the arm tips extend towards the axis to form a cavity, the shape of the cavity is a upturned “C” type with its mouth upwards.

7. The monolithic metallic self-ligating bracket as claimed in claim 5, wherein the outer edge in the upper end of the arm tip of the at least two locking catch devices is smoothly curved into an arc that slants towards the arm tip's ending.

8. The monolithic metallic self-ligating bracket as claimed in claim 1, wherein the locking catch devices are unsymmetrically placed on the two sides of the slot axis.

9. The monolithic metallic self-ligating bracket as claimed in claim 1, wherein the locking catch devices are all placed at one same side of the axis.

10. The monolithic metallic self-ligating bracket as claimed in claim 5, wherein rest locking catch devices are unsymmetrically placed about the arch wire slot axis or all the rest locking catch devices are at a same side of the arch wire slot axis.
